(19) United States
(12) Patent Application Publication
(10) Pub. No.: US 2005/0076186 A1
(43) Pub. Date: Apr. 7, 2005

(54) Systems and methods for improving the x86 architecture for processor virtualization, and software systems and methods for utilizing the improvements

(75) Inventor: Eric P. Traut, Bellevue, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation

(21) Appl. No.: 10/857,702

(22) Filed: May 28, 2004

Related U.S. Application Data
(60) Provisional application No. 60/508,747, filed on Oct. 3, 2003.

(51) Int. Cl. G06F 9/455

(52) U.S. Cl. 712/1; 718/1

(57) ABSTRACT

The present invention is directed to improvements to the processor architectures, and more specifically the x86 architecture, to correct shortcomings in processor virtualization. Several embodiment of the present invention are directed to the utilization of at least one virtualization control bit to determine whether the execution of a specific instructions cause a privilege-level exception (e.g., GP0) when executed outside of a privilege ring (e.g., outside of ring-0). Several additional embodiments are directed to the utilization of a virtual assist register to implement at least one virtual assist feature. And several additional embodiments are also directed to utilization of a bit for enabling a virtual protected mode that, when a processor in running in a protected mode, causes said processor, which is otherwise executing as if it is running in protected mode, to execute normally with exceptions to handle special virtualization challenges.

### CROSS-REFERENCE

This application claims benefit of U.S. Provisional Application No. 60/508,747, entitled “SYSTEMS AND METHODS FOR IMPROVING THE X86 ARCHITECTURE FOR PROCESSOR VIRTUALIZATION, AND SOFTWARE SYSTEMS AND METHODS FOR UTILIZING THE IMPROVEMENTS”, filed Oct. 3, 2003 (Atty. Docket No. MSFT-2841), the entire contents of which are hereby incorporated herein by reference.

### TECHNICAL FIELD OF THE INVENTION

The present invention relates to the field of processor virtualization and corresponding hardware and software. More specifically, the present relates to improvements to the x86 architecture to correct shortcomings in said architecture regarding processor virtualization, and even more specifically to software that utilizes these improvements to the x86 architecture.

### BACKGROUND OF THE INVENTION

Many technologies originally developed for mainframe systems have recently been resurrected for use in personal computers. Examples include multi-processor implementations, vector (SIMD) instruction sets, internal error checking and reporting, error correction and redundancy, and hot-swappable hardware components. Another mainframe-derived technology that is becoming more important in the PC world is the concept of a virtual machine (or VM for short).

VMs are resurfacing in the PC world for several reasons. First, modern PCs and PC-based servers are highly capable machines that are often underutilized. Second, as PC users adopt next-generation operating systems, they are looking for backward-compatibility solutions that preserve their prior investments in software and computing infrastructure. Third, in an environment where all PCs are connected to the Internet, security threats become an increasing concern, so users are looking for ways to isolate potentially dangerous software. And fourth, software developers are realizing that their capacity to deliver increasingly complex systems is bottlenecked by testing resources and capabilities. VMs can be used to streamline testing processes and increase capacity for automated test execution.

Gerald Popek, an early pioneer in VM research, defined a virtual machine as “an efficient, isolated duplicate of a real machine.” The latter requirement of isolation dictates that each virtual machine possess its own set of hardware (including I/O channels, peripheral devices, hard drives, etc.). This can be accomplished by dedicating specific hardware components (buses, memory, drives, etc.) to each VM. Alternatively, virtual hardware devices can be written in software and implemented using shared resources on the host machine. In contrast, however, the VM requirement for efficiency requires good processor virtualization which, in the x86 (IA32) architecture, is largely absent. Therefore, what is needed are techniques and improvements for good processor virtualization in the x86 architecture, and the invention herein discloses such techniques and improvements for efficient processor virtualization and better accommodating efficient virtualization in the x86 architecture.

### SUMMARY OF THE INVENTION

The present invention is directed to improvements to the processor architectures, and more specifically the x86 architecture, to correct shortcomings in processor virtualization. Several embodiment of the present invention are directed to the utilization of at least one virtualization control bit to determine whether the execution of a specific instructions cause a privilege-level exception (e.g., GP0) when executed outside of a privilege ring (e.g., outside of ring-0). Several additional embodiments are directed to the utilization of a virtual assist register to implement at least one virtual assist feature. And several additional embodiments are also directed to utilization of a bit for enabling a virtual protected mode that, when a processor in running in a protected mode, causes said processor, which is otherwise executing as if it is running in protected mode, to execute normally with exceptions to handle special virtualization challenges.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed.

FIG. 1 is a block diagram representing a computer system in which aspects of the present invention may be incorporated;

FIG. 2A is a block diagram illustrating the general registers of an x86 processor;

FIG. 2B is a block diagram illustrating the segment registers of an x86 processor;

FIG. 2C is a block diagram illustrating the EFLAGS register of an x86 processor;

FIG. 3 is a block diagram illustrating the logical layering of the hardware and software architecture for an emulated operating environment in a computer system;

FIG. 4 is a block diagram illustrating a virtualized computing system;

FIG. 5 is a block diagram illustrating an alternative embodiment of a virtualized computing system comprising a virtual machine monitor running alongside a host operating system;

FIG. 6 is a block diagram illustrating the fields (corresponding to specific processor functionality) for one embodiment of the virtual assist; and

FIGS. 7A, 7B, and 7C illustrate three scenarios that form the base cases for an inductive proof of the recursive virtualization feature, and FIGS. 7D and 7E illustrate two recursive scenarios based on the three base cases of FIGS. 7A, 7B, and 7C.

### DETAILED DESCRIPTION OF ILLUSTRATIVE EMBODIMENTS

The inventive subject matter is described with specificity to meet statutory requirements. However, the description itself is not intended to limit the scope of this patent. Rather, the inventor(s) have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

Computer Environment

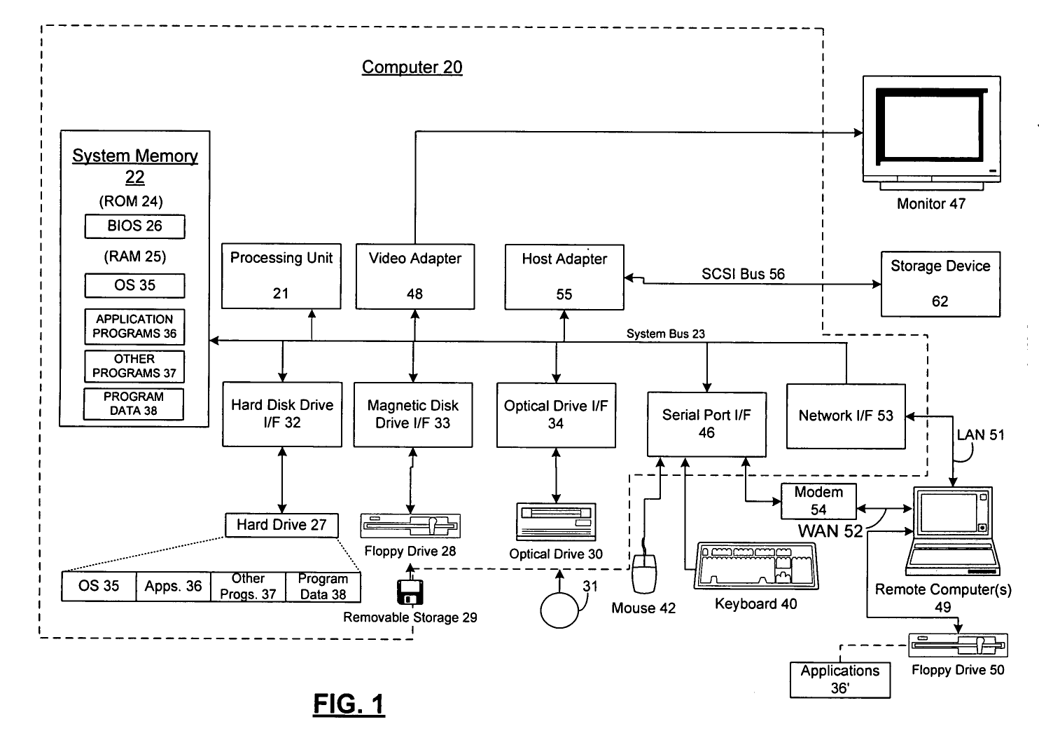

Numerous embodiments of the present invention may execute on a computer. FIG. 1 and the following discussion is intended to provide a brief general description of a suitable computing environment in which the invention may be implemented. Although not required, the invention will be described in the general context of computer executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand held devices, multi processor systems, microprocessor based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the personal computer 20, such as during start up, is stored in ROM 24. The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise wide computer networks, intranets and the Internet.

When used in a LAN networking environment, the personal computer 20 is connected to the LAN 51 through a network interface or adapter 53. When used in a WAN networking environment, the personal computer 20 typically includes a modern 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

While it is envisioned that numerous embodiments of the present invention are particularly well-suited for computerized systems, nothing in this document is intended to limit the invention to such embodiments. On the contrary, as used herein the term “computer system” is intended to encompass any and all devices comprising press buttons, or capable of determining button presses, or the equivalents of button presses, regardless of whether such devices are electronic, mechanical, logical, or virtual in nature.

Brief Overview of Registers

In general, registers are small data holding places that are a typical part of a computer processor. A register may hold a computer instruction, a storage address, or any kind of data (such as a bit sequence or individual characters), and some instructions specify registers as part of the instruction. For example, an instruction may specify that the contents of two defined registers be added together and then placed in a specified register (overwriting whatever contents were previously stored in this destination register). In most cases, a register must be large enough to hold an instruction—for example, in a 32-bit instruction computer, a register must be at least thirty-two (32) bits in length. In some computer designs, there are smaller registers—for example, half-registers and even quarter-registers—for shorter instructions or other purposes. Depending on the processor design and language rules, registers may be numbered or have arbitrary names.

The x86 (IA32) architecture has a specific set of registers comprising the general registers, the segment registers, the EFLAG register, the control registers, and a variety of others registers.

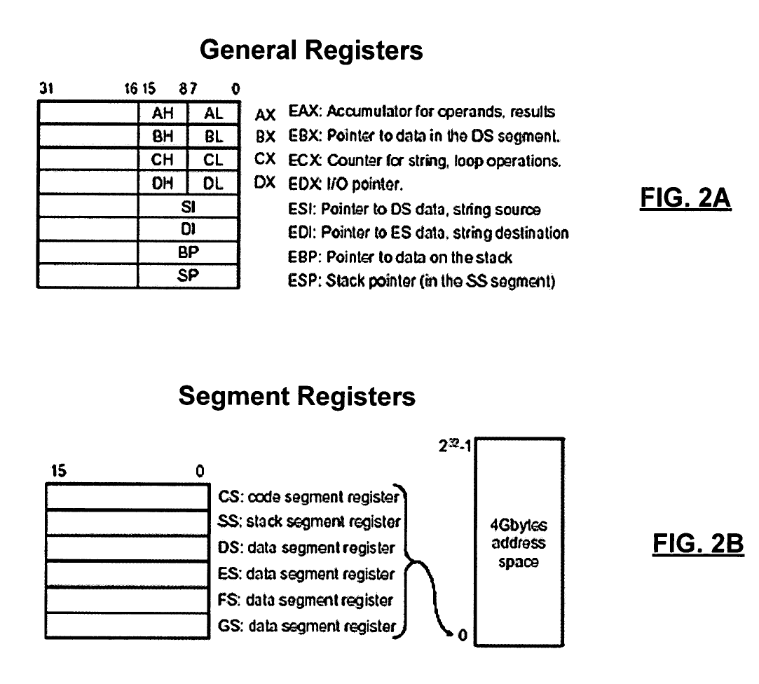

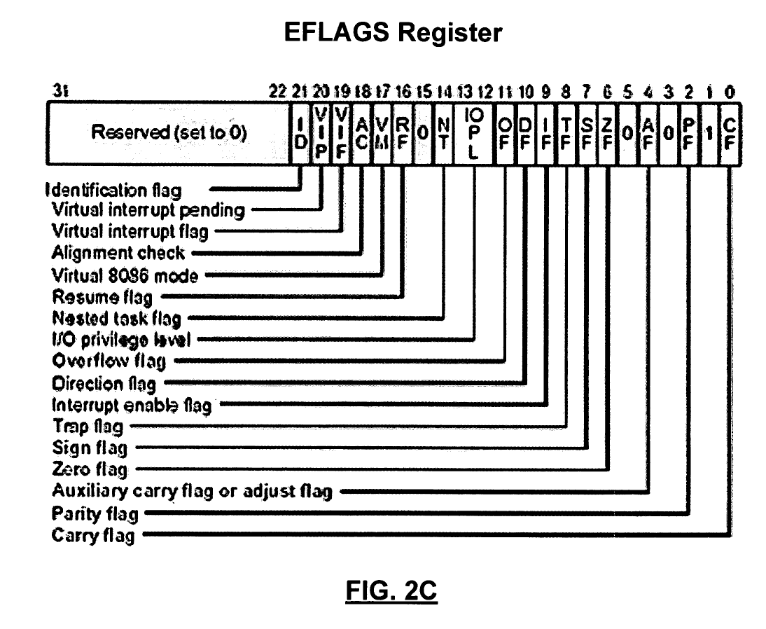

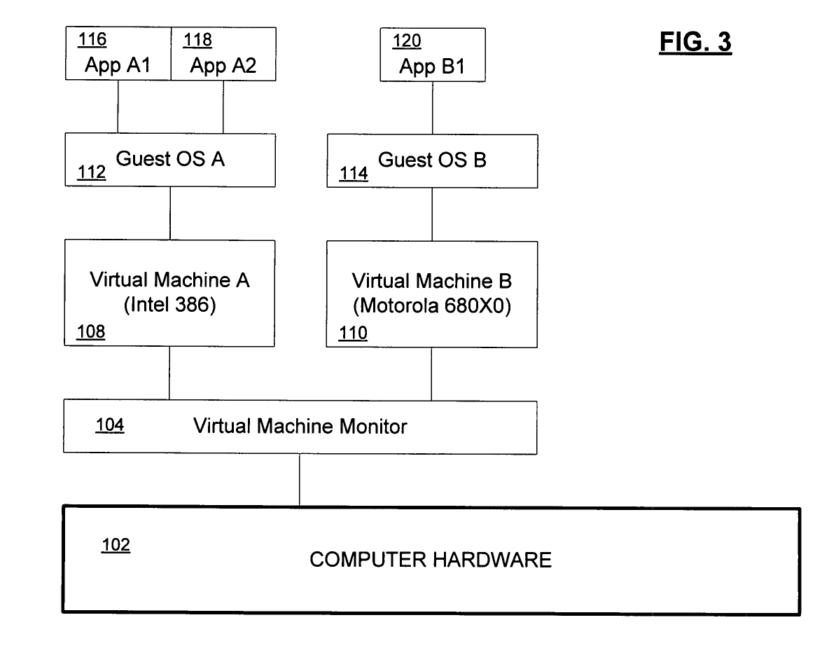

As illustrated in FIG. 2A, general registers comprise eight 32-bit general-purpose registers where the lower half of each can be addressed as a 16-bit register, and both the upper and lower half of each of the four 16-bit “X” registers can be addressed as an eight-bit register as illustrated in the figure.

As illustrated in FIG. 2B, the segment registers point to memory which is divided up into segments; however, most operating systems use an unsegmented approach to memory management and, thus, all of the segment registers are loaded with the same segment selector so that all memory references are to a single linear address space.

As illustrated in FIG. 2C, the EFLAGS register comprises a plurality of flags and unused “reserve” space.

The system registers (not shown) comprises a plurality of control registers that are discussed later herein.

Virtual Machine Architecture

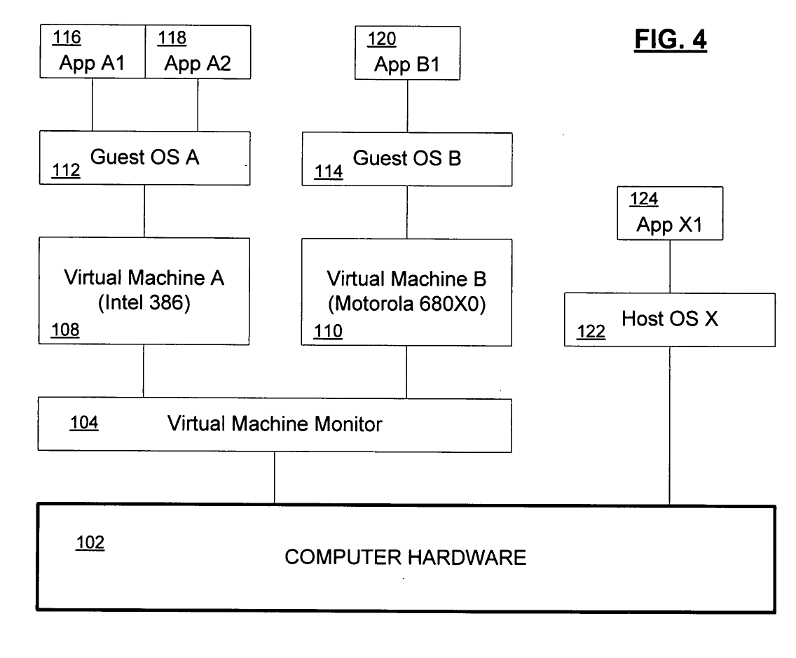

FIG. 3 illustrates a virtualized computing system comprising a virtual machine monitor (VMM) software layer 104 running directly above the hardware 102, and the VMM 104 virtualizes all the resources of the machine by exposing interfaces that are the same as the hardware the VMM is virtualizing (which enables the VMM to go unnoticed by operating system layers running above it). Above the VMM 104 are two virtual machine (VM) implementations, VM A 108 which is a virtualized Intel 386 processor, and VM B 110 which is a virtualized version of one or more of the Motorola 680X0 family of processors. Above each VM 108 and 110 are guest operating systems A 112 and B 114 respectively. Above guest OS A 112 are running two applications, application A1 116 and application A2 118, and above guest OS B 114 is Application B1 120.

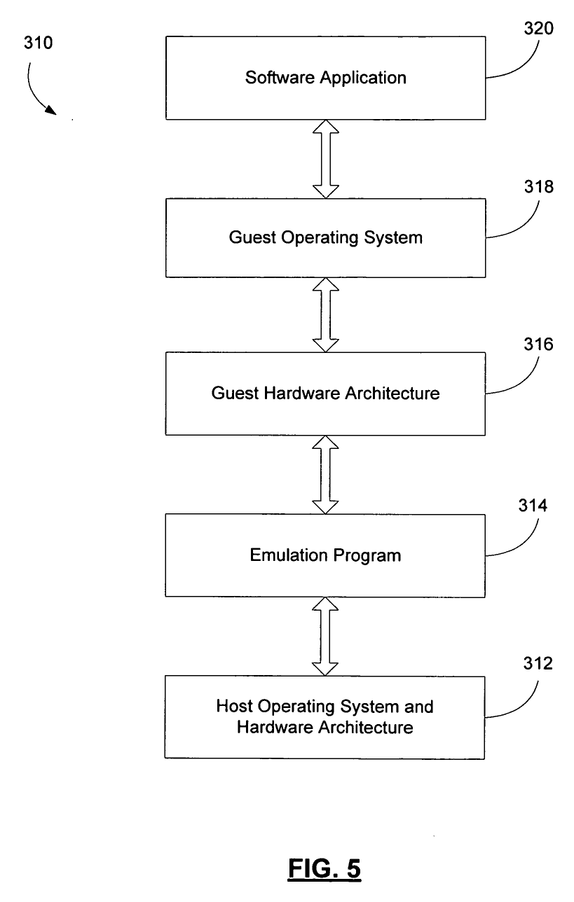

FIG. 4 illustrates a similarly virtualized computing system environment, but having a host (native) operating system X 122 that directly interfaces with the computer hardware 102, and above native OS X 122 is running application X 124.

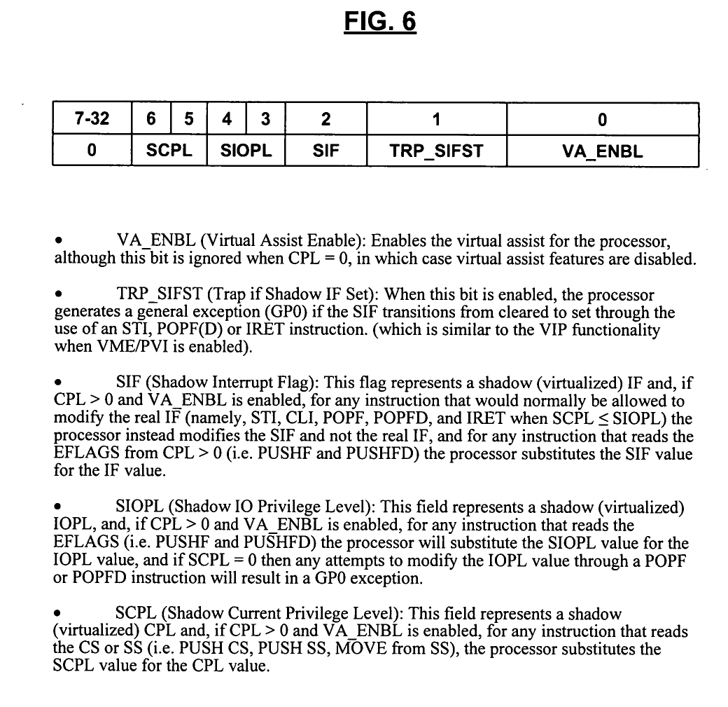

FIG. 5 is a diagram of the logical layers of the hardware and software architecture for an emulated operating environment in a computer system 310. An emulation program 314 runs on a host operating system and/or hardware architecture 312. Emulation program 314 emulates a guest hardware architecture 316 and a guest operating system 318. Software application 320 in turn runs on guest operating system 319. In the emulated operating environment of FIG. 3A, because of the operation of emulation program 315, software application 320 can run on the computer system 310 even though software application 320 is designed to run on an operating system that is generally incompatible with the host operating system and hardware architecture 312.

Overview of Processor Virtualization

There are two primary methods for processor virtualization: emulation and direct execution. A hybrid of these two approaches is also possible. Emulation involves the use of an interpreter or binary translation mechanism and is the only feasible choice when implementing a

VM on a system where the guest and host processors differ significantly. For example, the Connectix product Virtual PC for Mac implements an x86-based VM on a PowerPC-based Macintosh system. Emulation is also needed in some situations where the guest and host processors are the same but the processor provides inadequate virtualization support. Certain operating modes of the x86 architecture fall into this category.

While emulation is the most flexible and compatible virtualization mechanism, it is usually not the fastest. Both interpretation and binary translation impose a runtime overhead. In the case of interpretation, the overhead is often on the order of 90-95% (i.e. the resulting performance will only be 5-10% of the “native” performance). A binary translation mechanism is more complex than an interpreter, but it can mitigate some of the performance loss. A good binary translator imposes an overhead of 25-80% (i.e. the resulting performance is 20-75% of the “native” performance).

Direct execution is generally faster than emulation. A good direct-execution implementation comes within a few percentage points of native performance. Direct execution typically relies on processor protection facilities to prevent the virtualized code from “taking over” the system. In this regard, direct execution relies on the fact that most modern processors differentiate between user level and privileged level software. Software running in privileged mode is able to access all processor resources including registers, modes, settings, in-memory data structures, etc. User level mode, in contrast, is intended for untrusted software that performs the majority of the computational work in a modern system. To this end, most processors make a strict distinction between user-level state and privileged-level state, where access to privileged-level state is typically not allowed when the processor is operating at user level, which in turn allows trusted software (typically the operating system) to protect key resources and prevent a buggy or malicious piece of user-level software from crashing the entire system.

Direct execution of user-level code in a virtual machine is typically straight-forward and requires no special tricks because, when running virtualized user-level code, any privilege violations that occur on the hardware are simply passed along to the virtual machine, simulating the behavior of a non-virtualized processor running at user level. However, direct execution of privileged-level code is trickier because, for the virtual machine, this typically involves running privileged-level code in the VM at user level on the physical hardware. This can be problematic because privileged-level code is written with the assumption that it will have carte blanche access to all privileged state of the processor (afforded by the privilege-level mode) using a subset of instructions that directly or indirectly access privileged state (referred to generally as “sensitive instructions”).

When a sensitive instruction is executed by the processor running at user level, the processor typically generates a privilege violation trap because code executing at the user-level is not permitted to execute sensitive instructions. This violation trap, in turn, invokes an underlying trap handler resident in the virtual machine monitor (or VMM) which, in effect, forms the virtual hardware aspect of the virtual machine. The VMM's trap handler (for handling violation traps from the physical hardware) is responsible for intercepting the violation trap and, in regard to the VM, for emulating the expected effects or results of the privileged instruction, and then for returning control back to the subsequent instruction to be executed in the VM.

Emulation of a privileged instruction in this way often involves the use of shadow state that is private to a particular VM instance. For example, if a processor architecture includes a “privileged mode register” (PMR), any attempt to read from or write to the PMR from user level code causes a trap. In this event, the VMM's trap handler would determine the cause of the trap and refer to a PMR shadow value that is private to the instance of the associated VM. Interestingly enough, this PMR value may be different from the value currently held in the host processor's PMR (that is, the PMR for the physical hardware). For continued operations, the VM would continue to access the shadow PMR while the host operating system would continue to access the real PMR.

However, depending on the frequency of trapping instructions and the cost of handling a trap, this technique may impose a significant performance penalty. Early VMMs developed by IBM and Amdahl reached a limit of 80-95% of native performance. The 10-15% performance loss was primarily due to this trapping overhead. Later implementations have overcome this limitation by effectively “inlining” the trap handling within microcode, which eliminated the need for trapping for all but the most complex privileged instructions.

Strict Virtualization

An idealized processor intended for virtualization is said to be strictly virtualizable. Several modern processors (including PowerPC and DEC Alpha) meet these requirements. Unfortunately, IA32 and IA64 do not. Simply put, a strictly virtualizable processor allows for the implementation of a direct execution virtualization mechanism that meets the following requirements:
The VMM must be able to stay “in control” over processor and system resources.
Software running within the VM (whether at user or privileged level) should not be able to tell that it is running within a virtual machine.

Goldberg, who did significant early research in the field of virtual machines, formally defined several requirements for a processor to support virtualization. In less formal (and more modern) terms, a strictly virtualizable processor must exhibit the following properties.

1. Incorporates an MMU (or similar address translation mechanism).

2. Provides two or more privilege levels.

3. Divides all processor state into either privileged state or user state; privileged state should include any control or status fields that indicates the current privilege level.

4. Causes a trap when any access to privileged state (whether read or write) is attempted at user level.

5. Optionally causes a trap when user-level code attempts to access non-privileged state that should be virtualized (e.g. timer values, performance counters, processor feature registers).

6. All in-memory processor structures are either stored outside of the current address space or are protectable from errant or malicious memory accesses within the VM.

7. Any processor state at the time of an interrupt or trap can be restored to its pre-trap state after the interrupt or trap is handled.

In addition, a strictly virtualizable processor also supports the curious ability to virtualize recursively—i.e. running a virtual machine within a virtual machine.

Of course, while these required properties are necessary for correct processor virtualization, they do not guarantee efficient virtualization. Efficiency often requires additional processor facilities known collectively as “virtualization assists,” and there are several historical examples of virtualization assist mechanisms.

IA32: Virtual-8086 Mode and VME

Modern x86 processors contain a mode called virtual-8086 (or v86 for short). This mode allows well-behaved 8086 real-mode code to run within a protected-mode virtual machine. A set of virtualization assists were added starting with the 486 to reduce the virtualization overhead of code running within v86 mode. These virtual-8086 mode extensions (or VME for short) provide three specific virtualization assists:
a. A mechanism for efficiently virtualizing the IF (interrupt enable flag). This mechanism reduces the number of traps generated by the processor.
b. An I/O bit map that allows for direct v86 access to specific I/O port ranges.
c. An interrupt redirection bit map that allows specific interrupt vectors to be handled in a manner consistent with real-mode software without the intervention of the VMM.

Virtual-8086 mode and VME are useful for running legacy application-level software within a protected-mode operating system environment. However, v86 mode is not flexible enough to run all real-mode code.

IA32: PVI

At the same time VME was incorporated into the IA32 architecture, a companion facility was introduced for use with protected-mode code. This facility is referred to as protected-mode virtual interrupts (or PVI for short). PVI allows a VMM to implement a shadow IF (interrupt enable flag) but, unfortunately, this shadow IF (referred to as the VIF—or virtual interrupt flag) can be read by the code that is being virtualized. Furthermore, while the processor correctly handles certain instructions that modify the IF, it does not handle others. For these reasons, PVI has proven to be an ill-conceived and poorly architected virtualization assist which, in practice, is essentially useless.

IBM 390: VM Assist in Microcode

Some implementations of the IBM 390 contained hardware support for virtualization assists. The bulk of these assists were implemented using the downloadable microcode facility of these processors, and they generally provided modified semantics for frequently-executed privileged instructions executed within a virtual machine environment. In addition, for infrequent, complex instructions, a fast trapping mechanism was provided so the underlying VMM could quickly emulate the trapping instruction.

PowerPC: MMU “keys”

Most processors (including the x86) provide multiple privilege levels within the address translation unit. This allows an operating system to mark specific pages as “privileged” and any attempt by user-level software to access a privileged page results in a page fault. However, while tying the processor privilege level to the MMU privilege level is logical, it nevertheless presents a problem for virtual machine implementations because all code within a VM runs at user level.

The PowerPC architecture solves this problem by supporting the notion of MMU “keys”. A key is simply a single bit that controls whether the MMU should allow privileged memory accesses. Because a PowerPC supports two processor privilege levels, there are two independent keys. Typically, the privilege mode key is programmed in such a way that the MMU allows privileged memory accesses and the user mode key is programmed to prevent privileged memory accesses. By making the MMU setting independent of the processor mode, the VMM is able to run all of the VM code at user level but still request the appropriate MMU privilege semantics. When a mode transition occurs within the VM, the VMM simply reprograms the user-mode key.

The IA32 architecture, however, avoids the need for keys by supporting more than two privilege levels-rings 0, 1, 2, and 3 where ring 0 is a privileged-level mode and rings 1, 2, and 3 are variations of a user-level mode—where privileged-level MMU semantics are honored for privileged level ring 0 as well as user-level rings 1 and 2, but not for user-level ring 3. This allows a VMM to execute code at either ring 3 (user-level with no privileged page access) or rings 1 or 2 (user-level with privileged page access) depending on which MMU semantics are required.

PowerPC: Virtual Space IDs (VSIDs)

The MMU of the PowerPC also includes a segment translation mechanism whereby the top four bits of a logical address are used to index that address into an array of 16 segment registers. Each segment register contains a 24-bit VSID (virtual space ID) that defines the base address of a 256 MB address range within an overall 52-bit virtual address space. While PowerPC-based kernels swap out some or all of the segment registers when performing a process context switch, and because VSIDs are unique, no translation look-aside buffer (TLB) flushing is necessary because the processor's TLB is able to hold concurrent mappings from multiple 32-bit address spaces. As a result, this mechanism greatly reduces the need for TLB flushes, which not only speeds up a real PowerPC processor, but it also greatly improves performance in a virtual machine environment because TLB emulation is greatly simplified. An x86 processor, by contrast, requires that all non-global address translations be flushed from the TLB on every process context switch, and the expense of repopulating the TLB after a flush is especially high within a virtual machine because each virtual TLB miss requires a page fault at the cost several thousand cycles, thus negatively impacting performance.

PowerPC: Alignment Faults

It should be noted that the PowerPC processor does not automatically handle arbitrarily-aligned data accesses for all data types. For example, an eight-byte floating point load that is not at least four-byte aligned causes an alignment fault and the underlying operating system kernel would handle the misaligned load in software. The PowerPC helps to speed up alignment fault handling in two ways:
1. Fast-trapping: On most PowerPC implementations, trapping is extremely fast with the first instruction of the trap handler being executed only about a dozen cycles after the trap has been detected. During these dozen cycles, the pipelines are flushed and the prefetch queue is started to be filled.

2. Instruction decode assistance: The PowerPC partially decodes the instruction that causes the fault, and the decode information is placed in a special-purpose register and made available to the trap handler to more quickly determine the cause of the trap and respond accordingly.

Although this software-implemented alignment fault mechanism is not in fact a virtualization assist, it does exhibit many of the characteristics of an efficient trapping mechanism used by several embodiments of the present invention to assist with virtualization.

Shortcomings of the X86 Architecture

The x86 architecture contains many virtualization “holes” and presents a number of major challenges for a VMM implementer, several of which have been analyzed and published in the art. Some of the specific shortcomings of the x86 architecture are as follows:

Separation of Privileged and User State

The x86 architecture violates the requirement of user/privileged state separation in several places. The biggest problem involves the EFLAGS register which contains both user and privileged state. The following EFLAGS fields should be considered privileged: VIP, VIF, VM, IOPL, and IF. All other fields represent user state. In operation, instructions that read and write the privileged fields of the EFLAGS register (including PUSHF/PUSHFD, POPF/POPFD and IRET) should trap when executed from user mode, but they do not. (See FIG. 3.)

More specifically, the biggest challenge for x86 virtualization is related to the PUSHF and POPF instructions which are often used within kernel (ring 0) code to save and restore the state of the IF (interrupt enable flag). Within a virtual machine, this kernel code is executed at a higher ring level (e.g. at ring 1) and the IOPL is set such that IN/OUT instructions trap. Because the OS running within the VM should not be allowed to disable interrupts on the host processor, the actual IF value is set to 1 while the virtual machine code is running —regardless of the state of the virtual IF. This means the PUSHF instruction always pushes an EFLAGS value with IF=1. Furthermore, the POPF instruction always ignores the IF field in the popped EFLAGS value.

The other area where privileged and user state are mixed is in the CS and SS registers. The bottom two bits of these registers contain the CPL (current privilege level) which is privileged state. The upper 14 bits of these registers contain the segment index and descriptor table selector. Instructions that explicitly or implicitly access the CS/SS selector (including CALLF, MOV from SS and PUSH SS) do not trap when executed from user mode though they should. In contrast, other instructions that cause CS or SS to be pushed onto the stack (e.g. INT, INTO, JMPF through call gate, CALLF through call gate) can be trapped, thereby allowing the VMM to “fix up” the pushed value.

Access to Privileged State from User Mode

There are a number of “holes” in the x86 protection model that allow user-level code to directly access privileged processor state. These include the following instructions: SGDT, SIDT, SLDT, SMSW, and STR.

For a variety of reasons understood and appreciated by those of skill in the art, shadowing of the GDT, LDT, IDT and TR are necessary for correct virtualization. That means the TR, GDTR and IDTR will point to the VMM's shadow tables, not the table specified by the guest operating system upon which the virtual machine and its guest operating system are executing. Because non-privileged code can read from these registers, there's no way to correctly virtualize their contents.

In addition, several instructions that access the descriptors within the GDT and LDT do not trap when executed from non-privileged state. These include LAR, LSL, VERR, and VERW. Because GDT/LDT shadowing is necessary, these four instructions may execute incorrectly within a VM. If they could be made to cause a trap, the VMM could correctly emulate these instructions.

CPUID Virtualization

The CPUID instruction does not trap; however, as known and appreciated by those of skill in the art, it is important to trap on the CPUID when executed from a non-privileged mode in order to simulate new processor features or disable processor features within the virtual machine.

Non-restorable State

Context switching relies on the ability to save and restore the entire state of the processor; however, the x86 architecture does not allow this. In particular, the cached segment descriptor state for each of the six segments (DS, ES, CS, SS, FS, and GS) is stored internal to the processor at the time of a segment reload. This information cannot be accessed (except through the use of an SMI or other undocumented, back-door techniques), which in turn presents a barrier to correct virtualization. For example, if a piece of code loads a segment and then modifies the in-memory descriptor corresponding to that segment, a subsequent context switch will not be able to correctly restore the original segment descriptor information. Likewise, if the processor is in real mode and then switches to protected mode, the segments contain selectors that do not correspond to descriptors within the protected mode GDT/LDT. A context switch at this point would not be able to correctly restore the cached descriptors that were originally loaded within real mode.

Another example of non-restorable state is the unfortunate behavior of the IRETD instruction when used to return control to a less-privileged ring that uses a 16-bit stack. In this case, the upper half of the 32-bit ESP register is not correctly restored by the IRETD instruction. This appears to have been an oversight or bug in the original 32-bit x86 implementation because the INT instruction correctly pushes the full 32-bit ESP value onto the stack when transitioning through a 32-bit interrupt/trap gate.

PAUSE Instruction

As known and appreciated by those of skill in the art, the PAUSE instruction (a prefixed form of NOP) was recently added to provide hyperthreaded processors hints about spin lock execution. However, within a multi-processor (MP) virtual machine, spin locks pose a performance problem. For example, one virtual processor may spin on a lock that is held by a second virtual processor. If the second virtual processor is running on a thread that is not currently executing, the first virtual processor may spin for a long time, wasting processor cycles in the process. Therefore, it would be useful if the virtual machine monitor could be notified if a VM is spinning, which would allow the VMM to schedule another VM to run or to signal a second virtual processor thread to be scheduled.

Trap & Ring Transition Overhead

Virtualization relies heavily on the use of traps. Unfortunately, the overhead for trapping on a modern x86 processor is very high. The overhead for a round trip from ring 3 to ring 0 and back (i.e. an INT instruction and an IRET instruction) is very great, with cycle counts (as measured via the TSC) as high as 1250 a Pentium 4 processor and 500 on a Pentium 3 processor. While software-initiated ring transitions can make use of the optimized SYSENTER/SYSEXIT instructions, even these paths still impose a very high overhead of several hundred cycles.

In this regard, there are two high-frequency causes for traps within a typical guest OS: interrupt flag manipulation and I/O instructions. For example, kernel-level code frequently executes CLI/STI instructions that must be trapped to correctly virtualize the IF and, for a heavy I/O load on a 1 GHz processor, Microsoft Windows 2000 may execute over 100,000 CLI or STI instructions per second which, on a 1.2 GHz Pentium 3 processor, represents a 4.2% overhead and, on a 2 GHz Pentium 4, represents a 6.0% overhead.

In addition, within a virtual machine almost every IN or OUT instruction must be trapped to correctly virtualize the associated I/O device, once again the trapping overhead limits the overall performance of the virtual machine.

VMM Protection

Because the x86 makes use of in-memory data structures that are referenced logically rather than physically, the VMM code and data need to live within the VM's logical address space even though this makes the VMM code vulnerable to memory accesses performed within the VM. Of course, with ring-3 code the VMM's pages can be protected through the use of the user/privileged bit in the corresponding PTEs; however, there is no efficient way to protect the VMM's pages when running guest ring-0 code.

Incremental Improvements to the X86 Architecture

The following sections described various embodiments of the present invention for enhancing the compatibility and performance of virtual machines, and particular those virtual machines executing on the x86 processor architecture.

Virtualization Control Bit(s)

Several embodiments of the present invention are directed to a processor that utilizes of one or more bits in a predetermined register to control whether the execution of certain specific instructions causes a privilege-level exception (GP0) when executed in a ring level greater than zero. For certain embodiments, one or more bits in CR4 (the fourth control register) of the x86 architecture are used to control whether the execution of certain instructions cause a privilege-level exception (GP0) exception when executed in a ring level greater than zero. This control could be provided by a single control bit or, in alternative embodiments, could be handled by several separate bits. For one such embodiments, the following CR4 bits (each a “virtualization control bit”) are identified and utilized as indicated:
CR4_SPC: (Store Privilege State Control): Controls whether SGDT, SIDT, SLDT, SMSW and STR instructions trap in non-ring-0.
CR4_DTV: (Descriptor Table Virtualization Control): Controls whether LAR, LSL, VERR and VERW instructions trap in non-ring-0.
CR4_CPUID: (CPUID Virtualization Control): Controls whether the CPUID instruction traps in non-ring-0.
CR4_PAUSE: (PAUSE Virtualization Control): Controls whether the PAUSE instruction traps in non-ring-0.

In an alternative embodiment, a separate bit (CR4_IRET16) could control the behavior of the IRETD instruction—that is, whether this instruction returns with the normal 16-bit stack segment or the entire 32-bits of the ESP register.

In another alternative embodiment, one or more of the aforementioned control bits is located in a “Virtualization Control” model-specific register (MSR).

Virtual Assist Mechanism

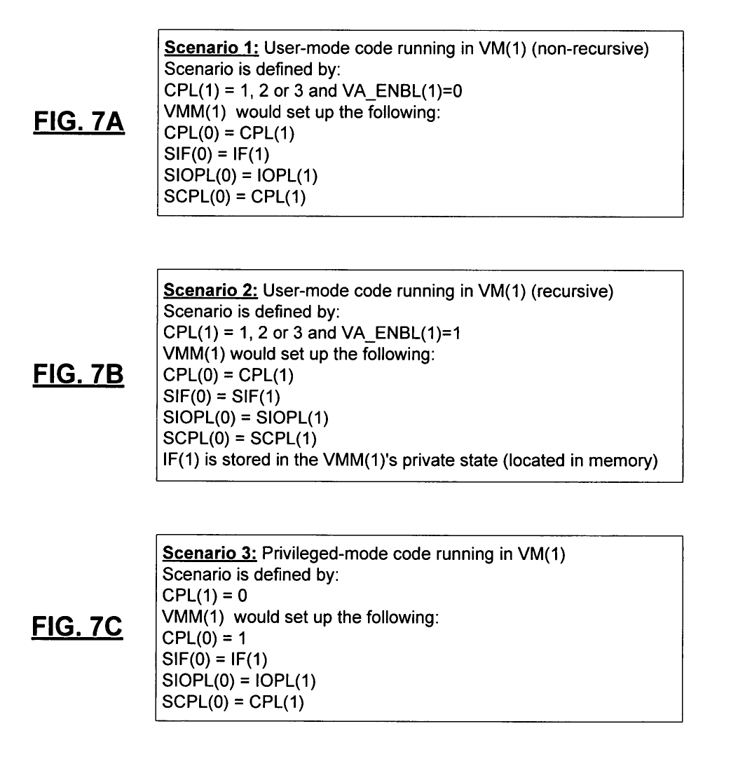

The EFLAGS register presents a difficult problem because it contains a mixture of privileged and user state. The most problematic field is the IF (interrupt enable flag), but other fields like the IOPL are also an issue. With this in mind, various embodiments of the present invention are directed to a “virtual assist,” that is, to enabling virtualization of the IF and IOPL fields of the EFLAGS register and the CPL fields of the CS and SS registers, where the utilization of these virtual fields would be controlled through the use of a new MSR (VA_CNTRL) with fields corresponding to specific processor functionality—that is, the “virtual assist components” for “certain virtual assist features”—as illustrated in FIG. 6 and as follows:
VA_ENBL (Virtual Assist Enable): Enables the virtual assist for the processor, although this bit is ignored when CPL=0, in which case virtual assist features are disabled.
TRP_SIFST (Trap if Shadow IF Set): When this bit is enabled, the processor generates a general exception (GP0) if the SIF transitions from cleared to set through the use of an STI, POPF(D) or IRET instruction. (which is similar to the VIP functionality when VME/PVI is enabled).
SIF (Shadow Interrupt Flag): This flag represents a shadow (virtualized) IF and, if CPL>0 and VA_ENBL is enabled, for any instruction that would normally be allowed to modify the real IF (namely, STI, CLI, POPF, POPFD, and IRET when SCPL≦SIOPL) the processor instead modifies the SIF and not the real IF, and for any instruction that reads the EFLAGS from CPL>0 (i.e. PUSHF and PUSHFD) the processor substitutes the SIF value for the IF value.
SIOPL (Shadow IO Privilege Level): This field represents a shadow (virtualized) IOPL, and, if CPL>0 and VA_ENBL is enabled, for any instruction that reads the EFLAGS (i.e. PUSHF and PUSHFD) the processor will substitute the SIOPL value for the IOPL value, and if SCPL=0 then any attempts to modify the IOPL value through a POPF or POPFD instruction will result in a GP0 exception.
SCPL (Shadow Current Privilege Level): This field represents a shadow (virtualized) CPL and, if CPL>0 and VA_ENBL is enabled, for any instruction that reads the CS or SS (i.e. PUSH CS, PUSH SS, MOVE from SS), the processor substitutes the SCPL value for the CPL value.

In addition to enabling the CPL, IOPL and IF to be virtualized, this virtual assist prevents many of the traps traditionally required to virtualize the IF. Moreover, the TRP_SIFST bit is similar to the VIP bit used with VME/PVI such that, when set, TRP_SIFST causes the processor to generate a GP0 exception after the SIF transitions from 0 to 1 which allows the VMM to deliver any pending virtual interrupts.

For various embodiments, the SIF is only modified in situations where the IF would normally be modified if VA_ENBL were disabled. Normally, this test involves the CPL and IOPL value—for example, if CPL>IOPL, then IF modifications would either cause an exception or would be ignored. However, when VA_ENBL is set and CPL>0, this test is performed using the shadow versions of CPL and IOPL (i.e. SCPL and SIOPL), although for all other internal processor privilege checks, the real CPL and IOPL continue to be used.

Note that this has implications for VME/PVI. When VME/PVI is enabled along with VA_ENBL, the normal VME/PVI algorithm is used except that SCPL and SIOPL are used instead of CPL and IOPL. Thus, for several such embodiments, the SIF is modified only in cases where the real IF would otherwise be modified—in other words, if the VME/PVI algorithm dictates that an instruction should cause an exception or modify the VIF, the SIF is not affected.

For certain embodiments, any exception or interrupt (including those generated by the INT 3, INT, INTO and ICEBPT instructions) will use the real value of IF, IOPL and CPL when pushing the EFLAGS, CS and (optionally) SS onto the stack. Likewise, any IRET executed from ring 0 will restore the real IF and IOPL from the EFLAGS popped from the stack.

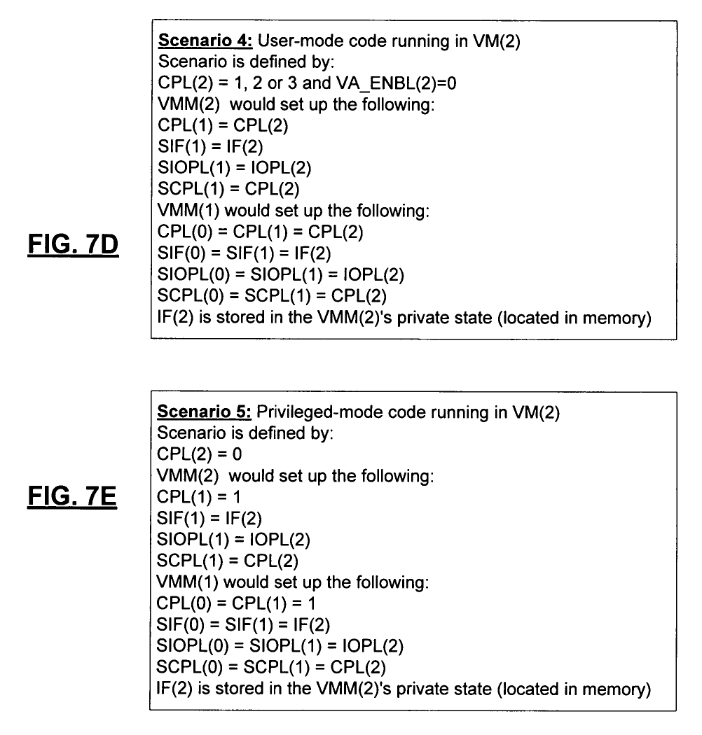

For various embodiments of the present invention, this virtualization assist mechanism is specifically designed with recursive virtualization in mind such that the VA_CNTRL is itself virtualizable. FIGS. 7A, 7B, and 7C illustrate three scenarios that form the base cases for an inductive proof of the recursive virtualization feature. For the purposes of clarity, subscripts (parenthetical numbers) are used to indicate the recursion level where a subscript of zero indicates the actual hardware resource, a subscript of one indicates a virtualized resource inside of a first-level VM, a subscript of two indicates a virtualized resource running within a second-level VM (i.e. a VM running within a first-level VM), and so on and so forth. For example, “CPL(1)=3” means that the current privilege level of the code running within a first-level VM is 3. FIGS. 7D and 7E illustrate two recursive scenarios based on the three base cases of FIGS. 7A, 7B, and 7C.

Saving and Restoring State

It is important for a VMM to be able to save and restore the segment register state including the internally cached descriptor. Despite this importance, there is no solution in the art to modify the x86 architecture in a simple way to accommodate this requirement. Various embodiments of the present invention are directed to a series of registers that are used to accessed the cached descriptors. For certain embodiments, a series of MSRs are used to access the cached descriptors, where four MSRs are used for each of the six segment registers: one for the selector, one for the base, one for the limit, and one for the flags.
XS_SELECTOR: Contains the current selector of XS
XS_LIMIT: Contains the current limit of XS
XS_BASE: Contains the current base of XS
XS_FLAGS: Contains the current descriptor flags for XS

This solution, however, is inadequate. The CS and SS segments are implicitly loaded during a ring transition, so by the time an exception handler is invoked, the previously cached value of CS and SS have been overwritten. For this reason, it may be necessary to introduce a “previous CS” and “previous SS” MSR.

This still doesn't solve the problem of restoring the state of the CS and SS descriptors when returning from an exception.

The proposed use of MSRs introduces a host of problems involving validation of segment flags. For example, loading a segment within protected mode requires the validation of protection flags. This MSR mechanism would need to duplicate this validation process or risk a situation whereby the descriptor flags represent an illegal descriptor (e.g. a CS segment that's not marked as a “code” segment).

Trap Overhead & Exception Cause Reporting

VMMs make extensive use of traps (e.g. to virtualize IN/OUT instructions). The overhead involved in cross-ring transitions continues to rise with each new processor family. Due to the complexity of a cross-ring transition on the x86, it's understandable that trapping will be expensive. However, a thousand cycles seems exorbitant. Any effort to minimize this overhead would improve virtualization performance. It would also improve performance of kernel calls and exception processing in non-VM applications.

For extremely efficient x86 virtualization, a specialized fast-path exception vector may be required. In addition, it would be helpful if the processor were able to indicate the cause of the exception—perhaps in an “exception cause” register. Because most x86 exceptions today are all reported as GP (general protection) exceptions, the GP exception handler within a VMM is extremely complex and inefficient. In many cases, determining the cause of the exception requires hundreds of cycles.

Holistic Improvements to the X86 Architecture

Several embodiments of the present invention are directed to (a) eliminating the need to perform “ring compression” (i.e. running virtualized ring-0 code at a higher ring level), (b) eliminating the need to shadow the GDT, LDT, IDT and TSS and avoids most of the high-frequency trap sources, and (c) allowing for highly efficient recursive virtualization.

Virtual Protected Mode (VPM)

Various embodiments of the present invention are directed to the introduction of a new processor mode bit to CR0 called VPME (virtual protected mode enable). This bit, like the paging enable bit, is only valid when running in protected mode. When VPM is enabled, the processor acts as if it was running in “normal” protected mode with the following changes:
1. External interrupts are not maskable even if the IF is set to zero in the EFLAGS. Any external interrupts detected by the processor cause a “VMM exception” to occur (see below for details);
2. An attempt to execute any of the following instructions (altogether, the “exception instructions”) causes a VMM exception:
   MOV to/from CR
   MOV from/from DR
   INVLPG
   LMSW
   SMSW
   RDMSR
   WRMSR
   RDPMC
   RSM
   RVPM (see below for explanation of RVPM instruction)
   CPUID (optionally; controlled through CR4)
   RDTSC (optionally; controlled through CR4)
   PAUSE (optionally; controlled through CR4)
   HLT (optionally; controlled through CR4)
   IN/INS
   OUT/OUTS
3. Any exception (either a software interrupt or hardware exception) may result in a VMM exception, depending on the state of a 256-bit exception bitmap (one bit for each IDT entry). If the bit in the bitmap is set to zero, the exception is handled normally. If it's set to 1, a VMM exception is generated instead;
4. When the IF is set (through the use of an IRET, STI, POPF, POPFD or a task switch), a VMM exception is generated if a virtual interrupt is pending (see below for details).

VMM Exceptions

A VMM exception is generated in response to several conditions (defined above). A VMM exception exits VPM and transfers control to the VMM's exception handler. When a VMM exception is generated, the processor does the following:
1. Saves the complete state of the six segment registers into 18 MSRs (three MSRs per segment). These three MSRs contain the following information:
VMP_XS_BASE: Contains the 32-bit or 64-bit base of the segment
VMP_XS_LIMIT: Contains the 32-bit or 64-bit limit of the segment
VMP_XS_FLG_SEL: Contains the 16-bit flags in the upper half and 16-bit selector in the lower half
2. Saves the EIP into register VMP_EIP.
3. Saves the EFLAGS into register VMP_EFLAGS.
4. Stores an “exception reason” code into register VMM_EXC_CODE. This code indicates the reason for the VMM exception (e.g. external interrupt, etc.).
5. If the exception code indicates a page fault, the linear faulting address (the value that would normally be placed in CR2) is stored to VMM_PFA.
6. Clears the VMPE bit in CR0, disabling VMP mode.
7. Loads the CS with a selector stored in VMM_CS. This selector is assumed to point to a wide-open executable segment (similar to the SYSENTER mechanism).
8. Loads the SS with a selector defined by the VMM_CS plus 8. This selector is assumed to point to a wide-open data segment (similar to the SYSENTER mechanism).
9. Loads the EIP and ESP from VMM_EIP and VMM_ESP, respectively.
10. Loads the EFLAGS with the value 2 (disabling interrupts, tracing, etc.).

To summarize, the following new MSRs would be required:

| MSR Name | Description |
|---|---|
| VMP_ES_BASE | ES segment base |
| VMP_ES_LIMIT | ES segment limit |
| VMP_ES_FLG_SEL | ES segment flags (in upper half) and selector (in lower half) |
| VMP_CS_BASE | CS segment base |
| VMP_CS_LIMIT | CS segment limit |
| VMP_CS_FLG_SEL | CS segment flags (in upper half) and selector (in lower half) |
| VMP_SS_BASE | SS segment base |
| VMP_SS_LIMIT | SS segment limit |
| VMP_SS_FLG_SEL | SS segment flags (in upper half) and selector (in lower half) |
| VMP_DS_BASE | DS segment base |
| VMP_DS_LIMIT | DS segment limit |
| VMP_DS_FLG_SEL | DS segment flags (in upper half) and selector (in lower half) |
| VMP_FS_BASE | FS segment base |
| VMP_FS_LIMIT | FS segment limit |
| VMP_FS_FLG_SEL | FS segment flags (in upper half) and selector (in lower half) |
| VMP_GS_BASE | GS segment base |
| VMP_GS_LIMIT | GS segment limit |
| VMP_GS_FLG_SEL | GS segment flags (in upper half) and selector (in lower half) |
| VMP_EIP | EIP to use in virtual protected mode |
| VMP_ESP | ESP to use in virtual protected mode |
| VMP_EFLAGS | EFLAGS to use in virtual protected mode |
| VMM_EXC_BITMAP0 | First 64 bits of the VMM bitmap (covering vectors 0 through |
| | 63) |
| VMM_EXC_BITMAP1 | Second 64 bits of the VMM bitmap (covering vectors 64 |
| | through 127) |
| VMM_EXC_BITMAP2 | Third 64 bits of the VMM bitmap (covering vectors 128 |
| | through 191) |
| VMM_EXC_BITMAP3 | Fourth 64 bits of the VMM bitmap (covering vectors 192 |
| | through 255) |
| VMM_CS | CS to use when leaving VMP |
| VMM_EIP | EIP to use when leaving VMP (points to VMM exception |
| | handler) |
| VMM_ESP | ESP to use when leaving VMP (points to VMM exception |
| | stack) |
| VMM_EXC_CODE | Code that identifies the cause of the exception (see below for |
| | encoding) |
| VMM_PFA | Faulting linear address at the time of a page fault that is |
| | reported to the VMM |
| VMM_CNTRL | Set of control bits for VMP mode. Currently, just two bits are |
| | defined: |
| | VMP_INT_PND: if set, a virtual interrupt is pending, and a |
| | “virtual interrupt pending” VMM exception should be |
| | generated when the IF is set within VPM mode. |
| | VMP_TF: if set, a single-step trace exception is generated |
| | (regardless of the state of the TF in the EFLAGS register). |
| | This allows for debugging within the guest environment |
| | that is transparent to the guest software. |

VMM exception codes would use the following encodings:

| Code | Description |
|---|---|
| 0-31 | Hardware exception; number indicates |
| | exception vector (with optional 16- |
| | bit exception code specified in top half) |
| 32 | Triple fault detected |
| 33 | INT |
| 34 | INTO |
| 35 | INT 3 |
| 36 | INT 1 (ICEBP) |
| 37 | External interrupt |
| 38 | Virtual interrupt pending |
| 39 | Virtual Trace Exception (due to VMM_TF facility) |
| 40-63 | Reserved |
| 64 | MOV to CRx |
| 65 | MOV from CRx |
| 66 | MOV to DRx |
| 67 | MOV from DRx |
| 68 | INVLPG |
| 69 | LMSW |
| 70 | SMSW |
| 71 | RDMSR |
| 72 | WRMSR |
| 73 | RDPMC |
| 74 | RSM |
| 75 | RVPM |
| 76-95 | Reserved |
| 96 | CPUID |
| 97 | RDTSC |
| 98 | PAUSE |
| 99 | HLT |
| 100-127 | Reserved |
| 128 | IN |
| 129 | INS |
| 130 | OUT |
| 131 | OUTS |
| 132-255 | Reserved |

RVPM Instruction

There are only two ways to enter VPM:
1. By executing an RVPM instruction from ring 0 when the VMPE bit is clear within CR0. (If the VMPE bit is set, a VMM exception is generated.)
2. By executing an RMS instruction from within system management mode and setting the VMPE bit within the in-memory value of CR0. This allows SMIs to interrupt code running within VPM.

Note that it's impossible to set the value of the VMPE bit in CR0 directly. Any attempt to do so using the MOV to CR0 instruction will cause a GP0 fault.

When an RVPM instruction is executed, the processor performs the following actions:
1. Loads the complete state of the six segment registers from the 18 VPM segment registers.
2. Loads the EIP from VMP_EIP and ESP from VMP_ESP.
3. Loads the EFLAGS from VMP_EFLAGS.
4. Sets the VMPE bit in CR0.

Virtual Interrupt Delivery

If the VMM wishes to deliver a virtual interrupt to the guest environment but interrupts are currently masked, the VMM needs a mechanism by which it can be notified when the IF is next set. This is done through the use of the VMP_INT_PND bit of the VMM_CTRL MSR. When this bit is set, the processor will generate a VMM exception when the IF is set while running in VPM mode.

Because of the defined behavior of STI, the VMM exception that indicates a pending virtual interrupt should not be generated until after the subsequent instruction (i.e. the instruction following the STI) has been executed. In other words, the VMM exception should be delivered in lieu of a hardware interrupt at the same place where the hardware interrupt would have occurred.

VM Debugging

Debugging code within the guest environment requires a single-step trace mechanism that is transparent to the guest code. One way to accomplish this is through the use of another bit in the VMM_CTRL register—the VMM_TF bit. When this bit is set, the processor generates a VMM trace exception after executing one instruction in VPM.

Protecting the VMM's Data & Code

As mentioned above, the VMM's data and code is vulnerable because it must be located within the guest's address space. We propose three ways the VMM could be protected:
1. Use the PAT (page attribute table) to define a new page type that is inaccessible when the processor is running within VPM. Any reference to these pages by the guest would result in a page fault.
2. Use two of the AVL bits in the PTEs to indicate whether a page was readable/writable from within VPM. A new bit in CR0 would control whether AVL bits were treated in this new way or in a traditional way (i.e. ignored by the processor).
3. Store the VMM code and data within physical memory and redefine the VMM exception mechanism to turn off address translation (similar to the SMI mechanism).

While the third choice is the safest option, it may be too expensive. Because VMM exceptions are high-frequency events, they need to be extremely efficient. If disabling address translation requires a flush of the processor's TLB, the overhead will be too great. In this case, the first or second choice would be preferred.

Accelerating Virtual Exceptions and Interrupts

The VPM can optionally incorporate a mechanism for efficiently simulating virtual exceptions and interrupts. There are two situations where the VMM may need to simulate interrupt/exception processing within the guest environment:
1. A virtual external interrupt is pending
2. The VMM exception handler was handed an exception that it wants to pass on to the guest

In these two cases, it would be useful if the RVPM instruction was able to simulate an exception or interrupt rather than returning directly to the specified VPM_EIP. This mechanism would involve the addition of another MSR: the VMM_EXC_ASSIST register. This register would contain the following fields:

VMM_EXC_ENBL (1 bit): If set, the RVPM instruction generates a simulated exception or interrupt. This bit is cleared after the exception is simulated to prevent additional processing.

VMM_EXC_DPL (1 bit): If set, the DPL of the IDT vector must be checked. (This bit should be cleared for external interrupt simulation.)

VMM_EXC_CODE (1 bit): If set, the exception code specified in the top half of VMM_CODE is pushed onto the stack during exception processing.

VMM_EXC_EIP_ADJ (3 bits): This field contains the value to be added to the VPM_EIP before pushing it onto the exception stack. (This value is needed for INT simulation.)

VMM_EXC_VECTOR (8 bits): This field contains the IDT vector to use when simulating the exception or interrupt.

Real mode support

Real mode can be virtualized using the VPM mechanism as long as the segment reload facility of the RVPM instruction allows v86 segments contain limits other than 0xFFFF. By indicating (through the use of the VMM exception bitmap) that all GP and SS exceptions should be redirected to the VMM's exception handler, the VMM should be able to virtualize all real-mode code using v86.

One potential modification that would speed up real-mode virtualization is the introduction of a separate VMM_CTRL bit that indicates when real-mode code is running (versus v86 code). When this bit (VMM_REAL) is set, any v86 segment reload should refrain from reloading the segment limit or flags, providing a behavior that is consistent with real mode.

Software for Utilizing Improvements to the X86 Architecture

Alternative embodiments of the present invention include software of any kind that utilizes, accesses, calls, or otherwise interacts with any implementation of the improvements characterized herein, and each specific X86 hardware improvement as disclosed herein further comprises software for utilizing said improvements.

### Conclusion

The various system, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the indexing functionality of the present invention.

While the present invention has been described in connection with the preferred embodiments of the various figures, it is to be understood that other similar embodiments may be used or modifications and additions may be made to the described embodiment for performing the same function of the present invention without deviating there from. For example, while exemplary embodiments of the invention are described in the context of digital devices emulating the functionality of personal computers, one skilled in the art will recognize that the present invention is not limited to such digital devices, as described in the present application may apply to any number of existing or emerging computing devices or environments, such as a gaming console, handheld computer, portable computer, etc. whether wired or wireless, and may be applied to any number of such computing devices connected via a communications network, and interacting across the network. Furthermore, it should be emphasized that a variety of computer platforms, including handheld device operating systems and other application specific hardware/software interface systems, are herein contemplated, especially as the number of wireless networked devices continues to proliferate. Therefore, the present invention should not be limited to any single embodiment, but rather construed in breadth and scope in accordance with the appended claims.

1. A method for improved processor virtualization, said method comprising the utilization of at least one virtualization control bit to determine whether the execution of a specific instructions cause a privilege-level exception (e.g., GP0) when executed outside of a privilege ring (e.g., outside of ring-0).

2. The method of claim 1 where said improved processor virtualization is for an x86 architecture processor.

3. The method of claim 2 wherein said virtualization control bit is a bit in the CR4 register.

4. The method of claim 3 wherein said virtualization control bit is a virtual control bit from among the following set of virtualization control bits: a virtualization control bit for controlling whether SGDT, SIDT, SLDT, SMSW and STR instructions trap when executed in a non-privilege ring; a virtualization control bit for controlling whether LAR, LSL, VERR and VERW instructions trap when executed in a non-privilege ring; a virtualization control bit for controlling whether a CPUID instruction traps when executed in a non-privilege ring; a virtualization control bit for controlling whether a PAUSE instruction traps when executed in a non-privilege ring; or a virtualization control bit for controlling whether an IRETD returns with a 16-bit stack segment or an entire 32-bit value from an ESP register.

5. The method of claim 2 wherein said virtualization control bit is a bit in a model-specific register (MSR).

6. A system for improved processor virtualization, said system comprising a processor that utilizes at least one virtualization control bit to determine whether the execution of a specific instructions cause a privilege-level exception (e.g., GP0) when executed outside of a privilege ring (e.g., outside of ring-0).

7. The system of claim 6 where said processor is an x86 architecture processor.

8. The system of claim 7 wherein said virtualization control bit is a bit in the CR4 register.

9. The system of claim 8 wherein said virtualization control bit is a virtual control bit from among the following set of virtualization control bits: a virtualization control bit for controlling whether SGDT, SIDT, SLDT, SMSW and STR instructions trap when executed in a non-privilege ring; a virtualization control bit for controlling whether LAR, LSL, VERR and VERW instructions trap when executed in a non-privilege ring; a virtualization control bit for controlling whether a CPUID instruction traps when executed in a non-privilege ring; a virtualization control bit for controlling whether a PAUSE instruction traps when executed in a non-privilege ring; or a virtualization control bit for controlling whether an IRETD returns with a 16-bit stack segment or an entire 32-bit value from an ESP register.

10. The system of claim 7 wherein said virtualization control bit is a bit in a model-specific register (MSR).

11. A computer-readable medium comprising computer-readable instructions for improved processor virtualization, said computer-readable instructions comprising instructions for the utilization of at least one virtualization control bit to determine whether the execution of a specific instructions cause a privilege-level exception (e.g., GP0) when executed outside of a privilege ring (e.g., outside of ring-0).

12. The computer-readable instructions of claim 11 further comprising instructions whereby said improved processor virtualization is for an x86 architecture processor.

13. The computer-readable instructions of claim 12 further comprising instructions whereby said virtualization control bit is a bit in the CR4 register.

14. The computer-readable instructions of claim 13 further comprising instructions whereby said virtualization control bit is a virtual control bit from among the following set of virtualization control bits: a virtualization control bit for controlling whether SGDT, SIDT, SLDT, SMSW and STR instructions trap when executed in a non-privilege ring; a virtualization control bit for controlling whether LAR, LSL, VERR and VERW instructions trap when executed in a non-privilege ring; a virtualization control bit for controlling whether a CPUID instruction traps when executed in a non-privilege ring; a virtualization control bit for controlling whether a PAUSE instruction traps when executed in a non-privilege ring; or a virtualization control bit for controlling whether an IRETD returns with a 16-bit stack segment or an entire 32-bit value from an ESP register.

15. The computer-readable instructions of claim 12 further comprising instructions whereby said virtualization control bit is a bit in a model-specific register (MSR).

16. A hardware control device for improved processor virtualization, said device comprising the utilization of at least one virtualization control bit to determine whether the execution of a specific instructions cause a privilege-level exception (e.g., GP0) when executed outside of a privilege ring (e.g., outside of ring-0).

17. The hardware control device of claim 16 where said improved processor virtualization is for an x86 architecture processor.

18. The hardware control device of claim 17 wherein said virtualization control bit is a bit in the CR4 register.

19. The hardware control device of claim 18 wherein said virtualization control bit is a virtual control bit from among the following set of virtualization control bits: a virtualization control bit for controlling whether SGDT, SIDT, SLDT, SMSW and STR instructions trap when executed in a non-privilege ring; a virtualization control bit for controlling whether LAR, LSL, VERR and VERW instructions trap when executed in a non-privilege ring; a virtualization control bit for controlling whether a CPUID instruction traps when executed in a non-privilege ring; a virtualization control bit for controlling whether a PAUSE instruction traps when executed in a non-privilege ring; or a virtualization control bit for controlling whether an IRETD returns with a 16-bit stack segment or an entire 32-bit value from an ESP register.

20. The hardware control device of claim 17 wherein said virtualization control bit is a bit in a model-specific register (MSR).

21. A method for improved processor virtualization, said method comprising the utilization of a virtual assist register to implement at least one virtual assist feature.

22. The method of claim 21 where said improved processor virtualization is for an x86 architecture processor (the “processor”).

23. The method of claim 22 wherein said virtual assist register is used to virtualize IF and IOPL fields of an EFLAGS register and CPL fields of CS and SS registers.

24. The method of claim 23 wherein said virtual assist register comprises at least one virtual assist component from among the following set of virtual assist components: an enable bit that enables the virtual assist for the processor when CPL is not equal to zero; an SIF flag that represents a shadow (virtualized) IF whereby, for any instruction that would normally be allowed to modify the real IF, the processor instead modifies the SIF and not the real IF, and whereby, for any instruction that reads the EFLAGS, the processor instead substitutes the SIF value for the IF value; an SIOPL that represents a shadow (virtualized) IOPL whereby, for any instruction that reads the EFLAGS register, the processor substitutes the SIOPL value for the IOPL value, and whereby, for any instructions that attempt to modify the IOPL value through a POPF or POPFD instruction, the processor will issues a general exception; a SCPL that represents a shadow (virtualized) CPL whereby, for any instruction that reads the CS or SS, the processor substitutes the SCPL value for the CPL value; and a shadow IF whereby the processor generates a general exception if the SIF flag transitions from cleared to set through the use of an STI, POPF(D) or IRET instruction.

25. The method claim 23 wherein said virtual assist register is a model-specific register (MSR).

26. A system for improved processor virtualization, said system comprising a processor that utilizes a virtual assist register to implement at least one virtual assist feature.

27. The system of claim 26 where the processor is an x86 architecture processor (the “processor”).

28. The system of claim 27 wherein said processor utilizes said virtual assist register to virtualize IF and IOPL fields of an EFLAGS register and CPL fields of CS and SS registers.

29. The system of claim 28 wherein said processor utilizes said virtual assist register to implement at least one virtual assist feature from among the following set of virtual assist features: enabling the virtual assist for the processor when CPL is not equal to zero; for any instruction that would normally be allowed to modify the real IF, a feature whereby the processor instead modifies the SIF and not the real IF, and for any instruction that reads the EFLAGS, a feature whereby the processor instead substitutes the SIF value for the IF value; for any instruction that reads the EFLAGS register, a feature whereby the processor substitutes the SIOPL value for the IOPL value, and for any instructions that attempt to modify the IOPL value through a POPF or POPFD instruction, a feature whereby the processor will issues a general exception; for any instruction that reads the CS or SS, a feature whereby the processor substitutes the SCPL value for the CPL value; and a feature whereby the processor generates a general exception if the SIF flag transitions from cleared to set through the use of an STI, POPF(D) or IRET instruction.

30. The system of claim 27 wherein said system utilizes a model-specific register (MSR) for implementing a virtual assist register.

31. A computer-readable medium comprising computer-readable instructions for improved processor virtualization, said computer-readable instructions comprising instructions for the utilization of a virtual assist register to implement at least one virtual assist feature.

32. The computer-readable instructions of claim 31 further comprising instructions whereby said improved processor virtualization is for an x86 architecture processor (the “processor”).

33. The computer-readable instructions of claim 32 further comprising instructions whereby said virtual assist register is used to virtualize IF and IOPL fields of an EFLAGS register and CPL fields of CS and SS registers.

34. The computer-readable instructions of claim 33 further comprising instructions whereby said virtual assist register comprises at least one virtual assist component from among the following set of virtual assist components: an enable bit that enables the virtual assist for the processor when CPL is not equal to zero; an SIF flag that represents a shadow (virtualized) IF whereby, for any instruction that would normally be allowed to modify the real IF, the processor instead modifies the SIF and not the real IF, and whereby, for any instruction that reads the EFLAGS, the processor instead substitutes the SIF value for the IF value; an SIOPL that represents a shadow (virtualized) IOPL whereby, for any instruction that reads the EFLAGS register, the processor substitutes the SIOPL value for the IOPL value, and whereby, for any instructions that attempt to modify the IOPL value through a POPF or POPFD instruction, the processor will issues a general exception; a SCPL that represents a shadow (virtualized) CPL whereby, for any instruction that reads the CS or SS, the processor substitutes the SCPL value for the CPL value; and a shadow IF whereby the processor generates a general exception if the SIF flag transitions from cleared to set through the use of an STI, POPF(D) or IRET instruction.

35. The computer-readable instructions claim 32 further comprising instructions whereby said virtual assist register is a model-specific register (MSR).

36. A hardware control device for improved processor virtualization, said device comprising a virtual assist register to implement at least one virtual assist feature.

37. The hardware control device of claim 36 where said improved processor virtualization is for an x86 architecture processor (the “processor”).

38. The hardware control device of claim 37 wherein said virtual assist register is used to virtualize IF and IOPL fields of an EFLAGS register and CPL fields of CS and SS registers.

39. The hardware control device of claim 38 wherein said virtual assist register comprises at least one virtual assist component from among the following set of virtual assist components: an enable bit that enables the virtual assist for the processor when CPL is not equal to zero; an SIF flag that represents a shadow (virtualized) IF whereby, for any instruction that would normally be allowed to modify the real IF, the processor instead modifies the SIF and not the real IF, and whereby, for any instruction that reads the EFLAGS, the processor instead substitutes the SIF value for the IF value; an SIOPL that represents a shadow (virtualized) IOPL whereby, for any instruction that reads the EFLAGS register, the processor substitutes the SIOPL value for the IOPL value, and whereby, for any instructions that attempt to modify the IOPL value through a POPF or POPFD instruction, the processor will issues a general exception; a SCPL that represents a shadow (virtualized) CPL whereby, for any instruction that reads the CS or SS, the processor substitutes the SCPL value for the CPL value; and a shadow IF whereby the processor generates a general exception if the SIF flag transitions from cleared to set through the use of an STI, POPF(D) or IRET instruction.

40. The hardware control device claim 37 wherein said virtual assist register is a model-specific register (MSR).

41. A method for improved processor virtualization, said method comprising the utilization of a bit for enabling a virtual protected mode that, when a processor in running in a protected mode, causes said processor, which is otherwise executing as if it is running in protected mode, to execute the following elements:
an external interrupt is not masked but instead cause an virtual machine monitor (VMM) exception to occur;
an attempt to execute an exception instruction causes a virtual machine monitor exception to occur, wherein an exception instruction is one of a set of exception instructions comprising at least one of the following: MOV to CR; MOV from CR; MOV to DR; MOV from DR: INVLPG; LMSW; SMSW; RDMSR; WRMSR; RDPMC; RSM; RVPM; CPUID; RDTSC; PAUSE; HLT; IN; INS; OUT; and OUTS;
a hardware exception or a software interrupt results in a VMM exception if, in regard to an exception bitmap where each bit corresponds to an IDT entry, when the bit in the bitmap is set to a first value (e.g. 1); and
when an IF is set through the use of an IRET, STI, POPF, POPFD or a task switch, an exception is generated if a virtual interrupt is pending;
where a VMM exception causes the processor state to be stored in at least one model-specific register (MSR).

42. A method for improved processor virtualization, said method comprising means for simulating virtual exceptions and interrupts via the use of a model-specific register (MSR).

43. A method for improved processor virtualization, said method comprising means for virtualizing a real mode by redirecting at least one GP or SS exception to a virtual machine monitor exception handler.
